(19) United States
(12) Patent Application Publication
(10) Pub. No.: US 2022/0411617 A1
(43) Pub. Date: Dec. 29, 2022

(54) FLAME-RETARDENT COMPOSITION AND MOLDED ARTICLE MADE THEREFROM

(71) Applicant: Star Thermoplastic Alloys & Rubbers, Inc., Broadview, IL (US)

(72) Inventors: Prakash SANJEEVAIAH, Orland Park, IL (US); Jeffrey Philip GEORGE, Oak Park, IL (US); Thomas Arthur DIESCHBOURG, Glenview, IL (US)

(21) Appl. No.: 17/848,502

(22) Filed: Jun. 24, 2022

Related U.S. Application Data
(60) Provisional application No. 63/215,413, filed on Jun. 25, 2021.

(51) Int. Cl. C08L 23/12; C08L 23/26; C08L 25/10; C08L 47/00; B29C 45/00; C08K 3/22

(52) U.S. Cl. CPC C08L 23/12; C08L 23/26; C08L 25/10; C08L 47/00; B29C 45/0001; C08K 3/22; B29K 2023/06; B29K 2023/12

(57) ABSTRACT

A flame-retardant composition including polypropylene, anhydride modified polyethylene and inorganic filler and a rigid molded article prepared with the flame-retardant composition. Also disclosed a method of molding a rigid article from the flame-retardant composition.

### CROSS REFERENCE TO RELATED APPLICATIONS

This is a written application for patent filed pursuant to 35 U.S.C. § 111(a). This application claims the benefit of the filing date under 35 U.S.C. § 119(e) from U.S. Provisional Patent Application Ser. No. 63/215,413, filed Jun. 25, 2021, which is hereby incorporated by reference in its entirety.

### TECHNICAL FIELD

The present disclosure relates to a flame-retardant composition, a molded article prepared with the flame-retardant composition and a method of molding an article from the flame-retardant composition. The present disclosure more particularly relates to a flame-retardant composition, a rigid molded article prepared with the flame-retardant composition and a method of molding a rigid article from the flame-retardant composition.

### BACKGROUND

Halogens have been used in the past to impart flame-retardant and smoke suppression properties to polyolefin formulations used to make molded articles or parts. The use of halogen-based flame retardants has drawbacks such as the evolution of acids when a polyolefin molded part starts to burn. Hydrated inorganic fillers such as magnesium hydroxide have been used as a replacement for halogen-based flame-retardants.

The use of hydrated mineral fillers in polyolefin formulations also suffers from certain disadvantages. A high level of magnesium hydroxide filler is required to achieve fire retardant specifications, such as 60 to 65 weight percent in polyolefin formulations. However, the high loading level of magnesium hydroxide filler in the polyolefin results in a significant decrease in flexibility and other mechanical properties, such as tensile strength and impact resistance.

What is therefore needed in the art is an inorganic mineral-filled polyolefin flame-retardant composition of matter that is useful for molding flame-retardant articles and parts, which can meet required fire-retardant specifications and which has improved mechanical properties.

### SUMMARY

According to certain embodiments, provided is a composition of matter comprising a polypropylene polymer, an anhydride modified polyethylene polymer, and inorganic filler.

According to other embodiments, provided is a molded article of manufacture comprising a composition of matter comprising a polypropylene polymer, an anhydride modified polyethylene polymer, and inorganic filler.

According to other embodiments, provided is a method for preparing a molded article comprising preparing a composition comprising propylene polymer, polyethylene polymer and inorganic filler; and molding said article of manufacture from said composition.

According other embodiments, provided is molded article of manufacture prepared by the process of preparing a composition comprising propylene polymer, polyethylene polymer and inorganic filler; and molding said article of manufacture from said composition.

### DETAILED DESCRIPTION

Throughout the present disclosure, the use of the articles “a,” “an,” and “the” refer to one or to more than one (that is, at least one) of the grammatical object of the article. By way of example, and not in limitation, “a compound” means one compound or more than one compound.

Throughout the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount, or quantity of any component in an embodiment can be determined by varying the value, determining the effectiveness of the compositions or methods for each value, and determining the range of values that produce compositions or methods with the desired degree of effectiveness in accordance with the present disclosure.

It should be understood that when a range of values is described in the present disclosure, it is intended that any and every value within the range, including the end points, is to be considered as having been disclosed. For example, “a range of from 10 percent to 100 percent” of a component, compound, composition, ingredient, reactant, etc. is to be read as indicating each and every possible number along the continuum between 10 and 100. It is to be understood that the inventors appreciate and understand that any and all values within the range are to be considered to have been specified, and that the inventors have possession of the entire range and all the values within the range.

Disclosed is a flame-retardant composition for preparing molded polymeric articles. According to certain embodiments, the flame-retardant composition of matter comprises a polypropylene polymer, an anhydride modified polyethylene polymer, and inorganic filler.

According to certain embodiments, the flame retardant composition of matter consists essentially of a polypropylene polymer, an anhydride modified polyethylene polymer, and inorganic filler.

According to certain embodiments, the flame-retardant composition of matter consists of a polypropylene polymer, an anhydride modified polyethylene polymer, and inorganic filler.

The flame-retardant composition of matter includes a polypropylene polymer. According to certain illustrative embodiments, the polypropylene polymer comprises a polypropylene impact copolymer. Without limitation, and only by way of illustration, a suitable polypropylene polymer is Pro-fax EP494T polypropylene impact copolymer commercially available from LyondellBasell Industries. According to certain embodiments, the amount of the polypropylene polymer, such as a polypropylene impact copolymer, present in the flame-retardant composition is greater than 40 weight percent, or greater that 45 weight percent, or greater than 50 weight percent, or greater than 55 weight percent, or greater than 60 weight percent, based on the total weight of the flame-retardant composition. According to certain embodiments, the amount of the polypropylene polymer, such as a polypropylene impact copolymer, present in the flame-retardant composition is in the range of about 40 weight percent to about 60 weight percent, or in the range of about 40 weight percent to about 50 weight percent, or in the range of about 45 weight percent to about 55 weight percent, or in the range of about 45 weight percent to about 50 weight percent, or in the range of about 47 weight percent to about 53 weight percent, or any other range within the range of about 40 weight percent to about 60 weight percent, based on the total weight of the flame-retardant composition.

The flame-retardant composition of matter includes a modified polyethylene polymer. According to certain embodiments, the flame-retardant composition of matter includes an anhydride modified polyethylene polymer. According to further illustrative embodiments, the polyethylene polymer comprises a maleic anhydride modified polyethylene polymer. According to further illustrative embodiments, the polyethylene polymer comprises a maleic anhydride grafted polyethylene polymer. Without limitation, and only by way of illustration, a suitable maleic anhydride modified polyethylene polymer is Dow Fusabond E265 commercially available from The Dow Chemical Company. According to certain embodiments, the amount of the anhydride modified polyethylene polymer, such as a maleic anhydride grafted polyethylene polymer, present in the flame-retardant composition is greater than 0 weight percent, or greater that 1 weight percent, or greater than 2 weight percent, or greater than 3 weight percent, or greater than 4 weight percent, or greater than 5 weight percent, or greater than 6 weight percent, or greater than 7 weight percent, or greater than 8 weight percent, or greater than 9 weight percent, or greater than 10 weight percent, based on the total weight of the flame-retardant composition. According to certain embodiments, the amount of the maleic anhydride modified polyethylene polymer present in the flame-retardant composition is in the range of about 1 weight percent to about 10 weight percent, or in the range of about 3 weight percent to about 10 weight percent, or in the range of about 5 weight percent to about 10 weight percent, or in the range of about 7 weight percent to about 10 weight percent, or in the range of about 3 weight percent to about 7 weight percent, or in the range of about 3 weight percent to about 5 weight percent, or in the range of about 5 weight percent to about 10 weight percent, or in the range of 5 weight percent to about 7 weight percent, or any other range within the range of about 1 weight percent to about 10 weight percent, based on the total weight of the flame-retardant composition.

The flame-retardant composition of matter includes an inorganic filler. According to certain illustrative embodiments, the inorganic filler comprises a metal hydroxide filler. The metal hydroxide filler may be magnesium hydroxide. Without limitation, and only by way of illustration, suitable metal hydroxide fillers are Vertex 60 SV and Zerogen 100 SP magnesium hydroxide commercially available from J.M. Huber Corporation. Vertex 60 SV and Zerogen 100 SP magnesium hydroxide are capable of imparting fire-retardance and smoke suppression in injection molded polyolefin systems. According to certain embodiments, the amount of the metal hydroxide filler, such as magnesium hydroxide, present in the flame-retardant composition is greater than 40 weight percent, or greater that 45 weight percent, or greater than 50 weight percent, or greater than 55 weight percent, or greater than 60 weight percent, or greater than 65 weight percent, based on the total weight of the flame-retardant composition. According to certain embodiments, the amount of the metal hydroxide filler, such as magnesium hydroxide, present in the flame-retardant composition is in the range from about 20 weight percent to about 70 weight percent, or from about 30 weight percent to about 60 weight percent, or from about 40 weight percent to about 70 weight percent, or in the range of about 40 weight percent to about 60 weight percent, or in the range of about 40 weight percent to about 50 weight percent, or in the range of about 40 weight percent to about 45 weight percent, or in the range of about 50 weight percent to about 70 weight percent, or in the range of about 50 weight percent to about 60 weight percent, or in the range of about 60 weight percent to about 70 weight percent, or any other range within the range of about 20 weight percent to about 70 weight percent, based on the total weight of the flame-retardant composition.

The flame-retardant composition of matter may further include block copolymer. According to certain embodiments, the further block copolymer may comprise a linear diblock or triblock copolymer. The further block copolymer may be selected from ethylene-octene copolymers, ethylene-propylene copolymers and styrene-butadiene copolymers. According to certain embodiments, the further block copolymer included in the flame-retardant composition is a linear triblock copolymer. Without limitation, and only by way of illustration, a suitable linear triblock copolymer is KRATON D1102 K commercially available from Kraton Corporation. KRATON D1102 K is linear triblock copolymer based on styrene and butadiene and having a polystyrene content in the range of about 26 to about 30. According to certain embodiments, the amount of the styrene butadiene triblock copolymer present in the flame-retardant composition is in the range of greater than 0 weight percent to about 5 weight percent, or in the range of about 1 weight percent to about 5 weight percent, or in the range of about 2 weight percent to about 5 weight percent, or in the range of about 3 weight percent to about 5 weight percent, or in the range of about 4 weight percent to about 5 weight percent, or in the range of about 1 weight percent to about 3 weight percent, or in the range of about 2 weight percent to about 3 weight percent, or any other range within the range of about 2 weight percent to about 3 weight percent, based on the total weight of the flame-retardant composition.

The flame-retardant composition of matter may include at least one antioxidant. According to certain illustrative embodiments, the antioxidant may be a phosphite based antioxidant. According to other illustrative embodiments, the antioxidant may be a phenolic based antioxidant. According to further embodiments, the flame-retardant composition may include a combination of both phosphite based and phenolic based antioxidants. Without limitation, and only by way of illustration, a suitable phosphite antioxidant and heat stabilizer is Irgafos® 168 commercially available from BASF Corporation. Without limitation, and only by way of illustration, a suitable phenolic based antioxidant and heat stabilizer is Irganox® 101 phenolic primary antioxidant commercially available from BASF Corporation.

The flame-retardant composition of matter does not contain any halogens and is therefore considered to be a halogen-free flame-retardant composition.

According to certain illustrative embodiments, the composition does not contain any thermoplastic elastomers.

A molded article of manufacture comprising the flame-retardant composition of matter comprising a polypropylene polymer, an anhydride modified polyethylene polymer, and inorganic filler is also disclosed.

A molded article of manufacture comprising the flame-retardant composition of matter consisting essentially of a polypropylene polymer, an anhydride modified polyethylene polymer, and inorganic filler is also disclosed.

A molded article of manufacture comprising a flame-retardant composition of matter consisting of a polypropylene polymer, an anhydride modified polyethylene polymer, and inorganic filler is also disclosed.

A method for preparing a molded article from the flame-retardant composition is also disclosed. The method comprises preparing a flame-retardant composition comprising propylene polymer, polyethylene polymer and inorganic filler and molding an article from the prepared flame-retardant composition. According to certain embodiments, the method for preparing a molded article from the flame-retardant composition comprises preparing a flame-retardant composition consisting essentially of propylene polymer, polyethylene polymer and inorganic filler and molding an article from the prepared flame-retardant composition. According to certain embodiments, the method for preparing a molded article from the flame-retardant composition comprises preparing a flame-retardant composition consisting of propylene polymer, polyethylene polymer and inorganic filler and molding an article from the prepared flame-retardant composition.

The article may be molded by any suitable molding process. According to certain embodiments, the method for molding the article comprises preparing a flame-retardant composition comprising propylene polymer, polyethylene polymer and inorganic filler and molding an article from the prepared flame-retardant composition, and injection molding an article from the flame-retardant composition. According to certain embodiments, the method for molding the article comprises preparing a flame-retardant composition consisting essentially of propylene polymer, polyethylene polymer and inorganic filler and molding an article from the prepared flame-retardant composition, and injection molding an article from the flame-retardant composition. According to certain embodiments, the method for molding the article comprises preparing a flame-retardant composition consisting of propylene polymer, polyethylene polymer and inorganic filler and molding an article from the prepared flame-retardant composition, and injection molding an article from the flame-retardant composition. Injection molding involves preparing a molten material mixture for the article in a heated vessel, injecting the molten material mixture into the cavity of a mold, cooling the mold to harden or otherwise solidify the molten material mixture contained within the cavity of the mold such that the hardened article has the configuration or shape of the cavity of the mold, and removing the molded article from the mold.

According to certain embodiments, a sample prepared from the flame-retardant composition exhibits a Shore A hardness as determined in accordance with ASTM D412A greater than 60. According to certain embodiments, a sample prepared from the flame-retardant composition exhibits Shore A hardness as determined in accordance with ASTM D412A in the range of 60 to 65, or in the range of 61 to 63. According to certain embodiments, a sample prepared from the flame-retardant composition exhibits Shore A hardness as determined in accordance with ASTM D412A may be 60, or 61, or 62, or 63, or 64, or 65.

The flexural modulus of a material is a measure of a material's stiffness or resistance to bend in response to a force a applied to a portion of a sample of the material. The higher the measured flexural modulus value, the more difficult it is for the material to bend. The lower the measured flexural modulus value of a material, the easier it is for the material to bend. According to certain embodiments, a sample prepared from the flame-retardant composition exhibits a flexural modulus of 2000 MPa or less, or 1900 MPa or less, or 1800 MPa or less, or 1700 MPa or less, or 1600 MPa or less, or 1500 MPa or less, or 1400 MPa or less, or1300 MPa or less, or 1200 MPa or less. According to other illustrative embodiments, a sample prepared from the flame-retardant composition exhibits a flexural modulus in the range of 2000 MPa to about 1200 MPa, or 2000 MPa to about 1300 MPa, or 2000 MPa to about 1400 MPa, or 2000 MPa to about 1500 MPa, or in the range of 2000 MPa to about 1600 MPa, or in the range of 2000 MPa to 1700 MPa, or in the range of 2000 MPa to about 1800 MPa, or in the range of 2000 MPa to about 1900 MPa, or 1800 MPa to about 1200 MPa, or 1700 MPa to about 1200 MPa, or 1800 MPa to about 1500 MPa, or 1800 MPa to about 1600 MPa, or 1800 MPa to about 1700 MPa, or any other range within the range of 2000 MPa to about 1200 MPa.

According to certain embodiments, a sample prepared from the flame-retardant composition exhibits a Tensile Strength in the range of 15 MPa to 25 MPa, or in the range of 20 MPa to 25 MPa, or from 15 MPa to 20 MPa, or from 16 MPa to 18 MPa, or any other range between 15 MPa to 25 MPa. According to certain embodiments, a sample prepared from the flame-retardant composition exhibits a Tensile Strength of 15, 16, 17, 18, 19, 20, 21, 22, 23, 24 or 25 MPa.

The Izod impact resistance of a material is a measure of a material's resistance to impact. According to certain embodiments, a sample prepared from the flame-retardant composition exhibits an Izod impact strength in the range of about 140 J/m to about 160 J/m, or about 140 J/m to about 150 J/m, or about 150 J/m to about 160 J/m, or about 145 J/m to about 155 J/m, or about 145 J/m to about 150 J/m, or about 150 J/m to about 155 J/m, or any other range within the range of about 140 j/m to about 160 J/m.

### EXAMPLES

The following examples are given solely for the purpose of illustration and are not to be construed as limitations of the present disclosure, as many variations of the invention are possible without departing from the spirit and scope of the present disclosure.

The following test methods were used to measure the physical properties of the inventive thermoplastic:

Shore A hardness testing performed in accordance with ASTM D2240,

Specific gravity measurements performed in accordance with ASTM D792,

Tensile Strength testing performed in accordance with ASTM D412A,

Flexural Modulus testing performed in accordance with ASTM D790,

Impact IZOD testing performed in accordance with ASTM D4812,

Apparent Viscosity testing performed in accordance with ASTM D3835.

Sample Preparation: Each of the different formulations was compounded on the twin screw extruder and pelletized. Pellet samples were used made standard plaques having the dimensions of 2″×4″×0.125″ thickness. These plaques were kept at room temperature for 24 hours and were then used to perform various physical tests.

Shore A Hardness test: 5 pairs of plaques were used for test. Each pair were stacked together to create 0.250″ thickness and kept on a uniform and stable bench top. Using Shore A durometer, 10 sec hardness measurement were taken at 3 points with each pair at 10 sec delay following the ASTM D2240 test method. Readings were recorded and average of 15 datapoints were reported as Shore A Hardness for the sample.

Specific gravity test: A small portion of about ½ inch size is cut from the molded plaque and tested for specific gravity following the ASTM D792 test method.

Tensile Strength test: 5 molded plaques are used for this test. Plaques were cut into test specimen using Die C in accordance with the ASTM protocol. The test specimen was held between two grips of tensile testing machine. The measurement is started when the specimen is stretched lengthwise until it breaks. The instrument records modulus at various stretch (elongation) levels, tensile at break, elongation and tabulates it. 5 specimens are run using same setup to achieve average of the results and reported as such in accordance with ASTM D412A.

The following components were used to prepare the sample formulations of the flame-retardant composition:

Profax EP 494T is a polypropylene impact copolymer.

Zerogen 100 SP from J.M. Huber Corporation is magnesium oxide that is surface with vinylsilane to improve compound rheology, powder dispersion and compound mechanical properties in certain polymer systems.

Zerogen 100 SP has the following chemical properties:

Magnesium Hydroxide: ≥99.5% (untreated MgOH base)

Calcium: ≤0.02%

Chloride: ≤0.02%

Iron: ≤0.005%

Zerogen 100 SP has the following physical properties:

Color: white

Specific gravity: 2.4 g/cm³

Moh's Hardness: 2.5 Mohs

Median Particle Size 0.8 microns

Specific Surface Area (BET): 5 m²/g

Huber Vertex 60 SV from J.M. Huber Corporation is magnesium oxide that is surface treated to improve compound rheology, powder dispersion and compound mechanical properties in certain polymer systems.

Vertex 60 SV has the following chemical properties:

Magnesium Hydroxide ≥99% (untreated MgOH base)

Calcium: ≤0.06%

Chloride: ≤0.03%

Iron: ≤0.08%

Vertex 60 SV has the following physical properties:

Color: white

Specific gravity: 2.36 g/cm³

Moh's Hardness: 2.5 Mohs

Median Particle Size by Laser light scattering: 3 microns

Specific Surface Area (BET): 12 m²/g

Kraton D1102 is linear copolymer based on styrene and butadiene with a styrene to rubber ratio of 28/72 commercially available from Kraton Polymers US LLC (Houston, Tex., US).

Irgafos® 168 is a phosphite antioxidant and heat stabilizer available from BASF.

Irganox® 1010 is a phenolic primary antioxidant and heat stabilizer available from BASF.

Dow Fusaboond P613 is a maleic anhydride grafted polypropylene polymer commercially available from The Dow Chemical Company.

Dow Fusabond P353 is a maleic anhydride grafted polypropylene polymer commercially available from The Dow Chemical Company.

Dow Fusabond E265 is a high density maleic anhydride grafted polyethylene polymer commercially available from The Dow Chemical Company.

The amounts of each of the components of the thermoplastic elastomeric overmold compositions set forth in the Tables below in “phr”. The term “phr” means. As used herein, the term “phr” means parts per one hundred parts rubber.

TABLE 1

| Example | C1 | C2 | 3 | 4 | 5 |
|---|---|---|---|---|---|
| Profax EP 494T PP | 100 | 54.7 | 53.7 | 51.7 | 49.7 |
| Zerogen 100 SP | 0 | 0 | 0 | 0 | 0 |
| Veretex 60 SV | 0 | 45 | 45 | 45 | 45 |
| Irganox 1010 | 0 | 0.15 | 0.15 | 0.15 | 0.15 |
| Irgafos 168 | 0 | 0.15 | 0.15 | 0.15 | 0.15 |
| Dow Fusabond E265 | 0 | 0 | 1 | 3 | 5 |
| Kraton D1102 | 0 | 0 | 0 | 0 | 0 |
| Dow Fusabond P613 | 0 | 0 | 0 | 0 | 0 |
| Dow Fusabond P353 | 0 | 0 | 0 | 0 | 0 |
| Example | 6 | 7 | 8 | C9 | C10 |
| Profax EP 494T PP | 47.7 | 44.7 | 47.7 | 47.7 | 47.7 |
| Zerogen 100 SP | 0 | 0 | 45 | 45 | 45 |
| Veretex 60 SV | 45 | 45 | 0 | 0 | 0 |
| Irganox 1010 | 0.15 | 0.15 | 0.15 | 0.15 | 0.15 |
| Irgafos 168 | 0.15 | 0.15 | 0.15 | 0.15 | 0.15 |
| Dow Fusabond E265 | 7 | 10 | 5 | 0 | 0 |
| Kraton D1102 | 0 | 0 | 2 | 2 | 2 |
| Dow Fusabond P613 | 0 | 0 | 0 | 5 | 0 |
| Dow Fusabond P353 | 0 | 0 | 0 | 0 | 5 |

Measured properties for compositions are listed for the various examples in Table below.

TABLE 2

| Example | C1 | C2 | 3 | 4 | 5 |
|---|---|---|---|---|---|
| Shore Hardness | 64 | 65 | 61 | 61 | 62 |
| Specific Gravity | 0.9 | 1.216 | 1.171 | 1.203 | 1.206 |
| Tensile Strength (psi) | 3292 | 3215 | 2362 | 2489 | 2441 |
| Tensile Strength (MPa) | 22 | 22 | 16 | 17 | 17 |
| Flexural Modulus (kpsi) | 243 | 395 | 298 | 259 | 234 |
| Flexural Modulus (MPa) | 1675 | 2726 | 2057 | 1784 | 1613 |
| Impact IZOD (ft-lb/in) | 2.8 | 2.8 | 2.82 | 2.9 | 2.88 |
| Impact IZOD (J/m)) | 149 | 149 | 151 | 155 | 154 |
| Apparent Viscosity | 8.9 | 16.3 | 14.9 | 16.7 | 17.5 |

| Example | 6 | 7 | 8 | 9 | 10 |
|---|---|---|---|---|---|
| Shore Hardness | 60 | 60 | 63 | 65 | 65 |
| Specific Gravity | 1.212 | 1.217 | 1.195 | 1.183 | 1.202 |
| Tensile Strength (psi) | 2458 | 2557 | 3598 | 3327 | 3730 |
| Tensile Strength (MPa) | 17 | 18 | 25 | 23 | 26 |
| Flexural Modulus (kpsi) | 232 | 231 | 188 | 355 | 303 |
| Flexural Modulus (MPa) | 1597 | 1595 | 1294 | 2450 | 2091 |
| Impact IZOD (ft-lb/in) | 2.7 | 2.7 | 2.52 | 3.4 | 3.3 |
| Impact IZOD (J/m)) | 144 | 144 | 135 | 181 | 176 |
| Apparent Viscosity | 17.9 | 19 | 17.8 | 18.4 | 17.9 |

The results reported in Table 2 above demonstrate that the presently disclosed flame-retardant composition exhibits an improved flexural modulus while still maintaining comparable Shore A hardness, tensile strength, Izod impact strength and viscosity as filled polypropylene compositions without the anhydride modified polyethylene component.

The following further comparative examples in Table 3 were prepared using a maleic anhydride grafted polypropylene polymer in combination with the Profax EP 494T polypropylene impact copolymer, and the samples were evaluated for Shore A hardness, tensile strength, Izod impact strength and viscosity.

TABLE 3

| Example | C2 | C11 | C12 | C13 | C14 | C15 |
|---|---|---|---|---|---|---|
| Profax EP 494T PP | 54.7 | 53.7 | 51.7 | 49.7 | 47.7 | 44.7 |
| Zerogen 100 SP | 0 | 0 | 0 | 0 | 0 | 0 |
| Veretex 60 SV | 45 | 45 | 45 | 45 | 45 | 45 |
| Irganox 1010 | 0.15 | 0.15 | 0.15 | 0.15 | 0.15 | 0.15 |
| Irgafos 168 | 0.15 | 0.15 | 0.15 | 0.15 | 0.15 | 0.15 |
| Dow Fusabond E265 | 0 | 0 | 0 | 0 | 0 | 0 |
| Kraton D1102 | 0 | 0 | 0 | 0 | 0 | 0 |
| Dow Fusabond P613 | 0 | 1 | 3 | 5 | 7 | 10 |
| Dow Fusabond P353 | 0 | 0 | 0 | 0 | 0 | 0 |

Measured properties for compositions are listed for the comparative examples of

Table 3 are set forth in Table 4 below.

TABLE 4

| Example | C2 | C11 | C12 | C13 | C14 | C15 |
|---|---|---|---|---|---|---|
| Shore | 65 | 64 | 66 | 65 | 66 | 68 |
| Hardness | | | | | | |
| Specific | 1.216 | 1.23 | 1.22 | 1.21 | 1.22 | 1.22 |
| Gravity | | | | | | |
| Tensile | 3215 | 2445 | 2890 | 3344 | 3536 | 3649 |
| Strength | | | | | | |
| (psi) | | | | | | |
| Tensile | 22 | 17 | 20 | 23 | 24 | 25 |
| Strength | | | | | | |
| (MPa) | | | | | | |
| Flexural | 395 | 386 | 427 | 407 | 418 | 406 |
| Modulus | | | | | | |
| (kpsi) | | | | | | |
| Flexural | 2726 | 2658 | 2945 | 2809 | 2884 | 2801 |
| Modulus | | | | | | |
| (MPa) | | | | | | |
| Impact IZOD | 2.8 | 3.06 | 3.58 | 3.74 | 3.78 | 3.8 |
| (ft-lb/in) | | | | | | |
| Impact IZOD | 149 | 163 | 191 | 200 | 202 | 203 |
| (J/m)) | | | | | | |
| Apparent | 163 | 17.1 | 16.5 | 17.1 | 17.3 | 18.1 |
| Viscosity | | | | | | |

The comparative samples C11-C15 comprising a blend of the maleic anhydride grafted polypropylene polymer and the polypropylene impact copolymer exhibit a flexural modulus that is greater than the flexural modulus of comparative sample C2 (neat polypropylene impact polymer). The results set forth in Table 4 are surprising and unexpected as one having ordinary skill in the art would expect the addition of a maleic anhydride grafted polypropylene polymer to the polypropylene impact copolymer as a compatibilizing agent would result in an improvement to the flexural modulus.

While the composition of matter, molded article of manufacture, and methods for making same have been described in connection with various illustrative embodiments, it will be understood that the embodiments described herein are merely exemplary, and that one skilled in the art may make variations and modifications without departing from the spirit and scope of the embodiments. All such variations and modifications are intended to be included within the scope of the embodiments as described hereinabove. Further, all embodiments disclosed are not necessarily in the alternative, as various embodiments may be combined to provide the desired result. Therefore, the composition of matter, molded article and methods shall not be limited to any single embodiment, but rather construed in breadth and scope in accordance with the recitation of the appended claims.

1. A composition of matter comprising:
a polypropylene polymer;
an anhydride modified polyethylene polymer; and
inorganic filler.

2. The composition of matter of claim 1, wherein said polypropylene polymer comprises an impact polypropylene polymer.

3. The composition of matter of claim 1, wherein said inorganic filler comprises a metal hydroxide filler.

4. The composition of matter of claim 3, wherein said metal hydroxide filler comprises magnesium hydroxide filler.

5. The composition of matter of claim 1, wherein said polypropylene polymer is present in an amount of about 40 weight percent to about 60 weight percent based on the total weight of the composition of matter.

6. The composition of matter of claim 1, wherein said anhydride modified polyethylene polymer is present in an amount of about 1 weight percent to about 10 weight percent based on the total weight of the composition of matter.

7. The composition of matter of claim 1, wherein said inorganic filler is present in an amount of about 40 weight percent to about 70 weight percent based on the total weight of the composition of matter.

8. The composition of matter of claim 1, wherein said composition of matter further comprises a styrene—butadiene block copolymer.

9. The composition of matter of claim 8, wherein said styrene—butadiene block copolymer is present in an amount of greater than 0 weight percent to about 5 weight percent based on the total weight of the composition of matter.

10. The composition of matter of claim 1, wherein the composition of matter does not contain any halogens.

11. The composition of matter of claim 1, wherein the composition of matter does not contain any thermoplastic elastomer.

12. The composition of matter of claim 1, wherein the composition of matter exhibits a Shore A hardness in the range of 60 to 65.

13. The composition of matter of claim 1, wherein the composition of matter exhibits a flexural modulus less than 2000 MPa.

14. The composition of matter of claim 1, wherein the composition of matter exhibits a tensile strength in the range of 15 MPa to 25 MPa.

15. The composition of matter of claim 1, wherein the composition of matter exhibits an Izod impact resistance in the range of 140 J/m to 160 J/m.

16. A molded article of manufacture comprising the composition of matter of claim 1.

17. A method for preparing a molded article comprising:
preparing the composition of matter of claim 1; and
molding said article from said composition.

18. The method of claim 17, wherein said molding comprises injection molding.
